(19) United States
(12) Patent Application Publication
(10) Pub. No.: US 2015/0169799 A1
(43) Pub. Date: Jun. 18, 2015

(54) METHOD OF SIMULATION OF AN OPTOELECTRONIC DEVICE

(71) Applicant: Commissariat à I'Energie Atomique et aux Energies Alternatives, Paris (FR)

(72) Inventors: Julien Singer, Domene (FR); Pierre Brand, Aix Les Bains (FR); Philippe Thony, Entre-Deux-Guiers (FR)

(73) Assignee: Commissariat à I'Energie Atomique et aux Energies Alternatives, Paris (FR)

(21) Appl. No.: 14/411,662

(22) PCT Filed: Jun. 28, 2013
(86) PCT No.: PCT/EP2013/063692

§ 371 Date: Dec. 29, 2014

(30) Foreign Application Priority Data
Jun. 29, 2012 (FR) 1256235

(51) Int. Cl. G06F 17/50

(52) U.S. Cl. CPC G06F 17/5009

(57) ABSTRACT

A method of optical and electrical simulation of an optoelectronic device, the surface of which is intended to be illuminated has a texture formed of regular cones, under the effect of the illumination of the surface by an incident light beam having an intensity spectrum determined on the basis of the wavelength, the method being implemented by computer and comprising:

modelling the device in the form of a structure for which the illuminated surface is modelled by a planar surface, modelling the incident light beam by: a first light beam inclined relative to the normal to the surface with a first non-zero angle, simulating an angle of incidence of the incident beam on the texture of the surface of the device, and for which the intensity is equal to that of the incident beam. A second light beam is inclined relative to the normal to the surface with a second angle, simulating an angle of incidence of the reflected portion of the incident beam on the texture of the surface of the device, and it simulating the illumination of said surface by said first and second beams.

### FIELD OF THE INVENTION

The present invention relates to a method for optical and electric simulation of an optoelectronic device, applied by a computer, as well as to a corresponding computer program product.

### BACKGROUND OF THE INVENTION

Upon designing an optoelectronic device intended to receive a light flux, such as a solar cell for example, it is customary to simulate the optical and electric behavior of the device, in order to predict its performances.

For this purpose, simulation methods have been developed, which consist, from a model of the optoelectronic device, notably representative of the materials making up the device and of their optical and electric properties, of their dimensions, as well as from the manufacturing method of the device, of simulating illumination having a determined spectrum representative of the illumination to which will be subject the operating optoelectronic device, and of computing optical and electrical characteristics of the device.

These methods may in particular be applied by a computer and there exist software packages giving the possibility of making a digital model of the electronic device depending on the materials used and on the manufacturing method, and of simulating the application of a light beam having given characteristics on said digital model, in order to compute optical and electrical characteristics of the device.

These pieces of software generally belong to TCAD (acronym of “Technology Computer Aided Design”) software packages.

The simulated optical characteristics are typically the reflectivity of an incident beam, depending on the wavelength, which is expressed as the ratio (in %) between the intensity of the reflected beam and the intensity of the incident beam.

The simulated electric characteristics are generally the external quantum efficiency designated by the acronym EQE or the characteristic of the current versus voltage under illumination, noted as I(V) or IV.

For these simulations, the light illuminating the device has a defined spectrum, for example the solar spectrum for a photovoltaic cell.

The optoelectronic device is modeled as a structure having planar surfaces, including the surface intended to receive the illumination.

The characteristics of the structure are defined according to the materials used, to their layout and to the manufacturing method of the device.

Insofar that the experimental measurements are carried out in the laboratory according to normal incidence of the light beam, the simulations are themselves carried out by considering the incident beam normal to the surface of he structure.

FIG. 1 schematically illustrates a conventionally used model, appearing as a structure S having a planar illuminated surface S_{S}.

Said surface S_{S} is illuminated by an incident beam I of intensity i.

Upon arriving at the surface S_{S}, the beam I is split into an absorbed beam T of intensity t and a reflected beam R of intensity r, which are both normal to the planar surface S_{S}.

In order to compute the reflectivity, the optical simulation consists of applying to the structure an incident beam with a determined wavelength, for each wavelength for which prediction of the reflectivity is desired.

The illumination conditions forming the input data of the simulation comprise, for a monochromatic beam, the intensity and the wavelength of said beam and for a non-monochromatic beam, the intensity versus the wavelength.

The result of the optical simulation is the calculation of the reflected portion of the beam which, after normalization, provides the reflectivity of the optoelectronic device.

The thereby computed reflectivity may be compared with experimental measurements of reflectivity in order to validate the models and their parameters.

FIG. 2 is a logic diagram showing the principle of a conventional simulation of the reflectivity of a solar cell.

First of all a structure S is defined forming a virtual model of the optoelectronic device, this structure being defined depending on the design and manufacturing characteristics of the device.

Moreover illumination conditions I* are defined, comprising the properties (wavelength, intensity) of the incident beam.

An optical simulation S1 of the structure S is applied under illumination conditions I*.

The result Rs of this simulation is the reflected portion of the incident beam which, after normalization, provides the reflectivity Rn.

The thereby obtained reflectivity may then be compared with the reflectivity of the device measured experimentally, in order to validate the models and their parameters.

Electric simulation as for it includes a preliminary step for optical simulation consisting of computing the fraction of the incident beam absorbed by the structure.

This absorbed fraction is then converted into an electric quantity, i.e. the concentration of excess carriers.

This quantity is itself used in an electric simulation step aiming at computing the external quantum efficiency (EQE) or the characteristic of the current versus voltage under illumination (IV).

FIG. 3 is a logic diagram showing the principle of a conventional electric simulation of a solar cell.

First of all, a structure S is defined forming a virtual model of the optoelectronic device, this structure being defined according to design and manufacturing characteristics of the device, as well as on illumination conditions I* comprising the properties (wavelength, intensity) of the incident beam.

If the optical simulation described above has already been applied, it is naturally possible to reuse the structure S and the illumination conditions I* used for this simulation.

First of all, an optical simulation S2 of the structure S is applied under illumination conditions I*.

The result Ts of this simulation is the portion of the incident beam absorbed by the structure.

After conversion of this absorbed portion into the concentration of excess carriers in the structure, electric simulation S3 is applied, the result J of which is either the external quantum efficiency or the characteristics of the current versus voltage under illumination.

Now, the illuminated surface of the solar cells is not planar but textured, i.e. consisting of a plurality of irregularities comprising a succession of recesses and of raised portions.

This texturation has the purpose of reducing reflections occurring at the surface of the cell and therefore increasing the efficiency of the latter.

Generally, the texture appears as a plurality of pyramids formed by etching the surface of the cell.

These pyramids generally have similar geometry with each other but a distributed random size around an average value.

In certain cases, regular pyramids may be encountered, i.e. all the flanks of which have the same angle relatively to the average planar surface of the device.

It is also possible to encounter upside-down pyramids, i.e. the apex of which points towards the inside of the device.

The result of this texturation is that when an incident beam normal to the average surface of the structure is incident on one of these pyramids, its reflected portion may be incident to another pyramid and be subject to a new reflection.

FIG. 4 schematically illustrates this phenomenon of successive reflections on a device D illustrated as a section, and the illuminated surface S_{D} of which consists of a plurality of tilted facets.

The incident beam I is reflected a first time on a facet (radius R1) and partly absorbed in the device (ray T1), and the reflected ray R1 will itself be incident to an adjacent facet and is reflected on this facet (radius R2), while a portion is absorbed in the device (ray T2).

Generally, an incident beam therefore interacts at least twice with the cell before being sent back outwards.

Therefore, the amount of light transmitted into the device is more significant than in the case of a planar surface and the reflectivity is therefore lower.

In so far that the texture of the surface of the device has an influence on the optical and electric characteristics of the latter, it is therefore desirable that the simulation should take into account this additional complexity.

However, the simulation of the effect of the pyramids cannot be carried out with existing simulation software packages since the two-dimensional aspect of the pyramids cannot be taken into account by the transfer matrix method (TMM) which is customarily used in optical simulations.

In this respect, the studies of S. C. Baker-Finch and K. R. McIntosh, “Reflection of normally incident light from silicon solar cells with pyramidal texture”, Progr. Photovolt: Res. Appl. 2011, 19, pp 406-416, propose an optical simulation of the reflectivity of a silicon solar cell, the textured surface of which is covered with pyramids by using the so-called “ray tracing” method which includes the geometric plot of the path of a ray reflected by one or several facets of the pyramids.

However, if this method allows computation of the reflectivity of the structure, it ignores the light which penetrates into the silicon and therefore does not provide any information on the absorption of the light by the cell.

Therefore, it is not possible to determine the effects of the texturation on the electric characteristics—and therefore on the operation—of the cell.

Moreover, the “ray tracing” method does not allow the taking into account of the presence of possible antireflective layers, for which the thickness is very thin, deposited at the surface of the device.

Now, such layers also have an influence on the reflectivity of the device.

R. Dewan, I. Vasilev, V. Jovanov and D. Knipp, “Optical enhancement and losses of pyramid textured thin-film silicon solar cells”, J. Appl. Phys. 110, 013101 (2011), as for them, propose modeling of a solar cell by a structure having a textured surface formed with regular pyramids and carrying out optical simulation by using the so-called FDTD (acronym of Finite Difference Time Domain) method.

However, the quantum efficiency is computed from an analytic formula which is only based on optical considerations but does not take into account the results of the simulation.

Therefore, this is not, strictly speaking, a simulation of the electric properties of the cell but an estimation, for which accuracy may be insufficient.

Further, the FDTD method has the drawback of involving very long computation times, because of the number of pyramids to take into account (for example, for a model with a width of 1,000 μm and pyramids for which the base has a width of 10 μm, the computations have to be performed for about 100 pyramids).

An object of the invention is therefore to propose a method for simulating optical and electric properties of an optoelectronic device which gives the possibility of taking into account the texturation of the surface of said device.

This method has to be simple to apply and requires computation times which are not greater than the computation times required for conventional simulations based on a planar surface of the device.

This method should also be able to take into account different texturation geometries, according to the manufacturing method of the device.

This method should also allow the simulation of optional antireflective layers deposited on the surface of the device.

### SHORT DESCRIPTION OF THE INVENTION

According to the invention, a method for optical and electric simulation of an optoelectronic device is proposed, for which the surface intended to be illuminated has a texture formed with regular cones, under the effect of the illumination of said surface by an incident light beam having a determined spectrum of intensity versus the wavelength, said method being applied by a computer and characterized in that it comprises:
modeling said device as a structure, the illuminated surface of which is modeled by a planar surface,
modeling said incident light beam by:
   a first tilted light beam relatively to normal to said planar surface with a nonzero first angle, simulating an angle of incidence of the incident beam on the texture of the surface of the device, and the intensity of which is equal to that of the incident beam, and by
   a second tilted light beam relatively to the normal to said planar surface with a second angle, simulating an angle of incidence of the reflected portion of the incident beam on the texture of the surface of the device,
simulating the illumination of said planar surface by said first and second beams.

By “textured”, is meant that the illuminated surface is not smooth but has irregularities, i.e. a succession of recesses and of raised portions.

Because of the manufacturing method of solar cells, the texture preferably comprises a plurality of facets laid out so as to form regular cones.

As a reminder, a cone is defined as being a volume delimited by a set of half-lines passing through a same point (the apex) and supported on a closed contour (the base).

By “regular”, is meant the fact that for a same cone, all the facets are tilted by the same angle relatively to the base, said angle being the same for all the cones making up the textured surface. This does not exclude that the different cones defining said surface may have variable dimensions (for example, bases of different widths).

The term of “regular cone” used in the present text therefore covers the axisymmetrical cones, for which the base is circular and which are considered as having an infinity of facets, as well as regular pyramids, for which the base is polygonal (for example triangular, square, etc.) and which therefore have a finite number of facets.

The facets are tilted relatively to an average planar surface of the device, which is a planar surface parallel to the other planar surfaces of the device, and parallel with the surface of the model. In the appended figures, the average planar surface of the device is a horizontal surface, the normal to the surface being vertical.

The incident light beam may be monochromatic (in which case its spectrum consists of a single line at the relevant wavelength) or non-monochromatic, having a continuous or discontinuous spectrum over a range of wavelengths.

Preferably, each of said regular cones comprises a plurality (either finite or infinite) of facets tilted by an identical angle relatively to an average planar surface of the surface of the device; said first angle being equal to the angle between a facet and said average planar surface.

According to an embodiment, said regular cones are regular pyramids.

Advantageously, the second angle is defined as being the angle of incidence of the reflected portion of the first beam on a facet adjacent to the facet on which said first beam is incident.

From the simulation of the illumination of the planar surface by said first light beam, it is possible to compute the reflectivity of said first beam.

Moreover, from the simulation of the illumination of the planar surface by the second light beam, it is possible to compute the reflectivity of said second beam.

According to an embodiment of the invention, the illumination of said planar surface of the structure is simulated by a third light beam tilted relatively to the normal to said surface with a third angle, said third angle being defined as being the angle of incidence of the reflected portion of the second beam on a facet adjacent to the facet on which said second beam is incident.

According to an embodiment, the illuminated surface of the device comprises an opaque area.

In this case, for the simulation, the first beam is modeled as a first half-beam directed towards the opaque area and as a second half-beam symmetrical relatively to the normal for the surface, each half-beam being tilted relatively to said normal with said first non-zero angle and having an intensity equal to half of that of the first beam and the second beam is modeled as a first half-beam directed towards the opaque area and as a second half-beam symmetrical relatively to the normal to the surface, each half-beam being tilted relatively to said normal with said second angle and having an intensity equal to the half of that of the second beam.

It is then possible to compute the reflectivity of an incident beam on the textured surface by performing the product of the reflectivities of the beams with which the illumination of the planar surface has been simulated.

On the other hand, it is possible to compute the intensity of the second beam by multiplying the intensity of the first beam by the reflectivity of said first beam.

Also, it is possible to compute the intensity of the third beam by multiplying the intensity of the second beam by the reflectivity of said second beam.

Advantageously, it is possible to weight the intensity of the third beam with a probability coefficient dependent on the angle of the facet.

According to an embodiment, the incident beam is non-monochromatic and the reflectivity of the first, of the second and, if necessary of the third beam is computed for each of a plurality of wavelengths sampled from the spectrum of said incident beam, and the reflectivity of said incident beam is computed by performing the product of the reflectivities of said beams for each of said wavelengths.

On the other hand it is possible to compute an intensity spectrum of the second beam by multiplying the intensity of the first beam by the reflectivity of said first beam for each of said wavelengths.

It is further possible to simulate the illumination of the planar surface of the structure simultaneously by the first, the second and if necessary, the third beam and to compute the intensity absorbed by said structure.

Advantageously, from said absorbed intensity the concentration of the excess carriers are inferred in the structure under the effect of said illumination.

From said concentration of excess carriers, the external quantum efficiency and/or the characteristic of the current versus voltage of the optoelectronic device are computed.

According to the embodiment of the invention, during the simulation, the portion of the first, of the second and/or, if necessary, of the third beam transmitted into the structure is computed and the tilt of each transmitted portion is corrected by diverting it.

The invention also relates to a computer program product including a set of instructions which, once loaded onto a computer, allow the application of the method as described earlier.

Said product may be on any computer medium, such as for example a memory or a CD-ROM.

### SHORT DESCRIPTION OF THE DRAWINGS

Other features and advantages of the invention will become apparent from the detailed description which follows, with reference to the appended drawings wherein:

FIG. 1 is a diagram of a model of a known type used for simulating the optical and electric properties of an optoelectronic device,

FIG. 2 is a logic diagram showing the principle of conventional simulation of the reflectivity of a solar cell,

FIG. 3 is a logic diagram showing the principle of a conventional electric simulation of a solar cell,

FIG. 4 schematically illustrates the effect of the texturation of the surface on the interaction between an incident beam and the optoelectronic device,

FIG. 5 schematically illustrates the simulation principle according to the invention,

FIG. 6 is a sectional diagram of an optoelectronic device which may be the subject of a simulation according to the invention,

FIG. 7 is a logic diagram showing the principle of an optical simulation according to the invention,

FIG. 8 is a logic diagram showing the principle of an electric simulation according to the invention,

FIGS. 9A and 9B respectively show the reflectivity curves versus the wavelength obtained with a method according to the prior art not taking into account the texture of the illuminated surface and with the method according to the invention,

FIGS. 10A and 10B respectively show the external quantum efficiency (EQE) curves depending on the wavelength obtained with a method according to the prior art not taking into account the texture of the illuminated surface and with the method according to the invention,

FIGS. 11A and 11B respectively show the curves of the characteristic of the current versus the voltage under illumination (IV) obtained with a method according to the prior art not taking into account the texture of the illuminated surface and with the method according to the invention,

FIG. 12 is a sectional diagram of an alternative of an optoelectronic device which may be subject to a simulation according to the invention, comprising an opaque area on the textured surface,

FIG. 13 schematically illustrates an alternative of the simulation principle according to the invention, wherein the textured surface of the device is partly covered with an opaque area.

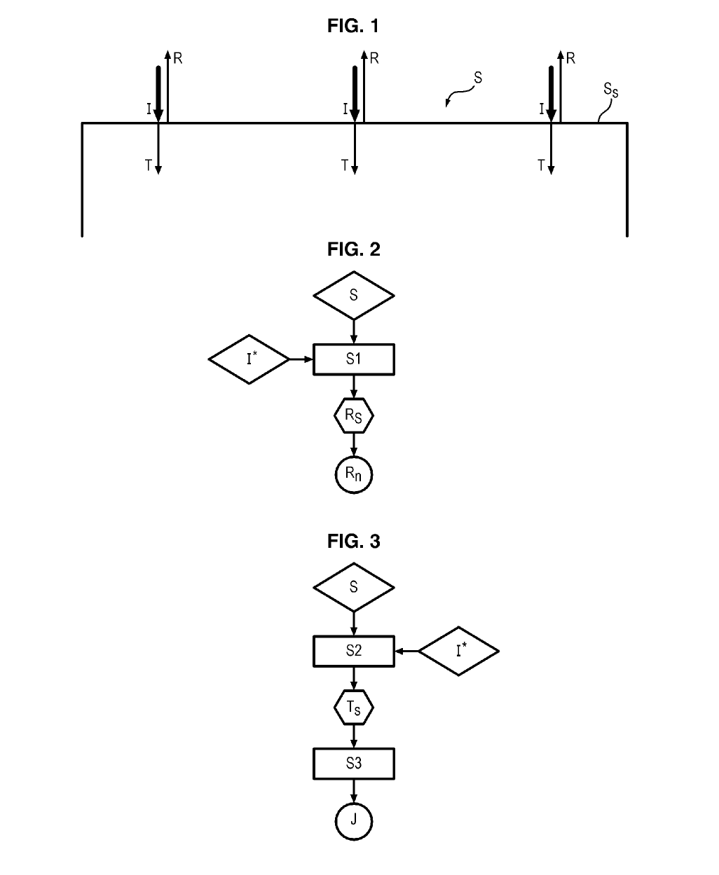

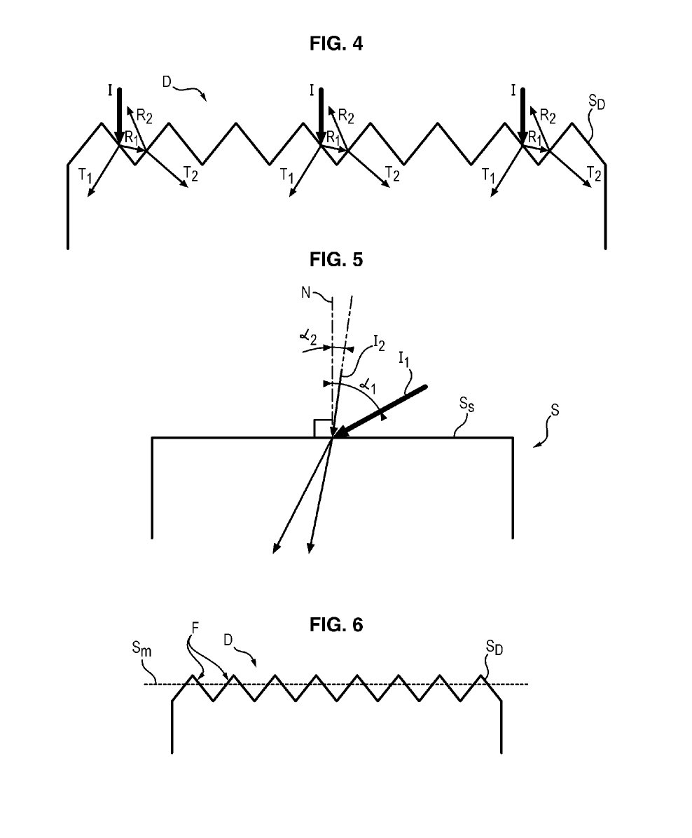

### DETAILED DESCRIPTION OF THE INVENTION

FIG. 5 illustrates the general principle of optical and electric simulation of an optoelectronic device, the surface of which intended to be illuminated is textured.

Said simulation is applied by a computer.

Said device is modeled as a structure S, the illuminated surface of which is modelled by a planar surface S_{S}.

In order to take into account the different reflections which may occur on the surface of the actual device, the incident light beam is not modelled by a single beam normal to the surface, but by two incident beams I₁ and I₂ tilted relatively to the normal N to the surface S, for which the angles of incidence are selected according to the texture of the surface of the device.

More specifically, a first light beam I₁ is tilted relatively to normal N to said surface with a first non-zero angle α₁.

The first beam I₁ thus simulates an angle of incidence of the incident beam on the texture of the surface of the device, and its intensity is equal to that of the incident beam I.

On the other hand, a second light beam I₂ is tilted relatively to the normal N to the surface S with a second angle α₂, simulating an angle of incidence of the reflected portion of the incident beam on the texture of the surface of the device.

According to a preferred embodiment of the invention, the device D, as illustrated in FIG. 6, has an illuminated surface S_{D}, the texture of which consists of an alternation of planar facets F tilted relatively to an average planar surface Sm.

Preferably, said facets are laid out relatively to each other in order to form regular cones.

Said cones have a regular shape, i.e. each of the facets forming their flanks has an identical angle relatively to their base, considered as being in a horizontal plane, and this angle is identical for all the cones.

Moreover, the cones may have different sizes, randomly distributed over the surface S_{D}.

With the technique customarily used for producing the surface texturation of a photovoltaic cell, The obtained cones are generally pyramids with a square base.

Generally, when the optoelectronic device is a photovoltaic cell, the technique customarily used for producing the surface texturation forms regular pyramids with a square base, for which the minimum width of the base is preferably greater than 1 μm.

Nevertheless, the invention is not limited to this particular texture but, as indicated above, applies to any texture consisting of regular cones.

Referring back to the definition of the angles of incidence of the first and second light beams, the angle αₗ of the beam I₁ is defined as being equal to the angle between a facet of the regular cone and a horizontal plane coinciding with the base of said cone.

As regards the beam I₂, the latter is considered as corresponding to the portion of the beam I₁ reflected on a facet of a cone and arriving on a facet of an adjacent cone.

In the case of regular cones, the angle α₂ is therefore defined as being equal to:

π−3α₁ radians.

The beams I₁ and I₂ moreover have the same wavelength as the incident beam for which illumination is desirably simulated.

Thus, if the incident beam is monochromatic, the beams I₁ and I₂ will have the same wavelength as the latter.

If the incident beam is non-monochromatic, the beams I₁ and I₂ will have the same wavelengths as the latter.

On the other hand, as this will be seen below, the respective intensities of each of said wavelengths for the beams I₁ and I₂ are not necessarily equal to that of the incident beam.

### Simulation of Reflectivity

In order to simulate the reflectivity of the textured surface, two optical simulations are carried out successively under different illumination conditions, i.e. with the beam I₁ and then the beam I₂ respectively with their respective angles of incidence.

In the case when the incident beam is monochromatic, the reflectivity is simulated for the corresponding wavelength.

In the case when the incident beam is non-monochromatic (case of the solar spectrum for example), the reflectivity is computed for a sample of wavelengths from among said spectrum.

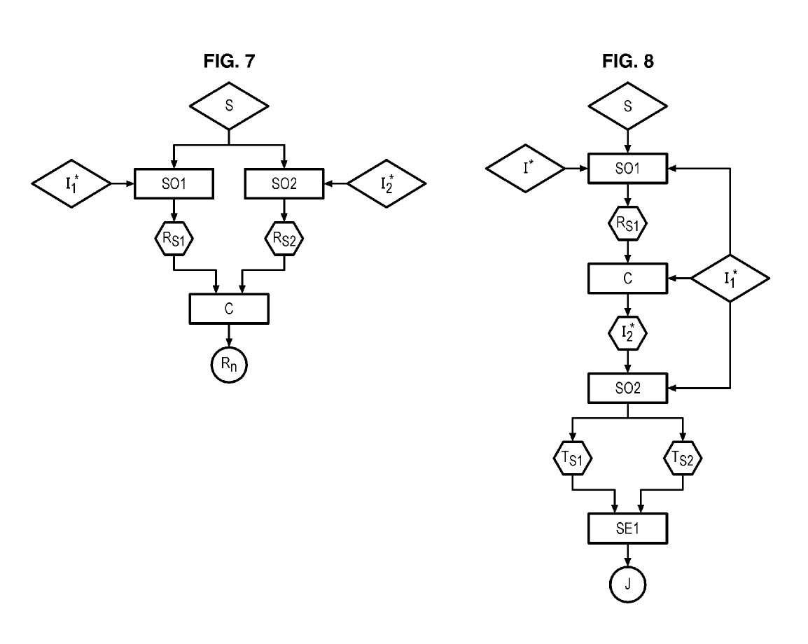

The logic diagram of FIG. 7 illustrates the principle of this optical simulation.

As explained above, the structure S is used with a planar surface which models the optoelectronic device, for which the surface is textured.

A first optical simulation SO1 consists of illuminating the surface S_{S} of the structure under the first illumination conditions I1*, i.e. those of the first beam I₁.

The result Rs1 of this first simulation is the reflectivity of the incident beam for the relevant wavelength(s).

A second optical simulation SO2 consists of illuminating the surface S_{S} of the structure under the second illumination conditions I2*, i.e. those of the second beam I₂.

The result Rs2 of this second simulation is the reflectivity of the beam reflected by a first facet for the relevant wavelength(s).

As the reflectivity is a standardized quantity, it is sufficient to work for this simulation with relative intensities and it is not necessary, within this scope, to compute the intensity of the portion of the incident beam transmitted through the surface of the structure.

The final reflectivity Rn of the incident beam on the textured surface is obtained by performing the product of both reflectivities simulated above (computation step C).

For this purpose, it is considered that two reflections on facet are representative of the path covered by all the rays.

With this assumption, the product of the reflectivities obtained by the first and the second simulation therefore is a relevant representation of the reflectivity of the textured surface illuminated by a normal incident beam.

However, there may exist particular cases for which this assumption is not verified, but, as this will be seen below, particular embodiments of the invention give the possibility of taking this into account and of nevertheless providing accurate results.

### Electric Simulation

Unlike the simulation of the reflectivity, the electric simulation may not be content with operating with relative intensities; on the contrary it is necessary to know the intensity of the beam transmitted through the surface of the device.

The transmitted light is the sum of the portion transmitted by the incident beam during its first interaction with a facet and of the portion transmitted by the beam once it has been reflected upon its interaction with a second facet.

The simulation is therefore carried out on a structure having a planar surface, on which is incident the first beam I₁ tilted by an angle α₁ (illumination conditions I1*) relatively to the normal and the second beam I₂ tilted by an angle α₂ (illumination conditions I2*).

The intensity of this second beam computed by means of the intensity and of the reflectivity of the first beam.

It is proceeded with in the following way, schematized in the logic diagram of FIG. 7.

As earlier, the structure S is used with a planar surface which models the optoelectronic device, for which the surface is textured.

A first optical simulation SO1 has the purpose of building the second beam as described above.

This first simulation SO1 is carried out under the first illumination conditions I1* and consists of simulating the reflectivity Rs1 of the first incident beam I₁.

The intensity of the second beam I₂ is then computed (step C) for each wavelength (as indicated above, a single wavelength is considered if the beam is monochromatic, sampling is considered if the beam is non-monochromatic) by multiplying the intensity of the first beam I₁ by its reflectivity Rs1.

For a non-monochromatic beam, a light spectrum is therefore obtained.

A second optical simulation SO2 is then carried out, wherein the illumination of the structure S is simultaneously simulated with the first illumination conditions I1* (beam I₁ with the intensity of the actual beam and the angle of incidence α₁) and the second illumination conditions I2* (beam I₂ with the intensity computed in step C and the angle of incidence α₂).

Both of these beams each transmit one portion (Ts1, Ts2, respectively) of their light intensity inside the structure S.

The absorbed portion of what has thus been transmitted inside the device is then converted into an electric quantity (concentration of excess carriers) like during a standard simulation, this concentration of carriers being itself used in an electric simulation SE1 applying techniques known per se to the person skilled in the art.

The result J of the electric simulation SE1 is either the quantum efficiency (EQE) or the characteristic of the current versus voltage under illumination (IV).

As compared with a known electric simulation, the obtained result is more accurate since it takes into account the concentration of excess carriers which is different, because of the texturation of the surface, from that of a device having a planar surface, and which is itself determined from both optical simulations SO1 and SO2 which take into account the texture of the surface.

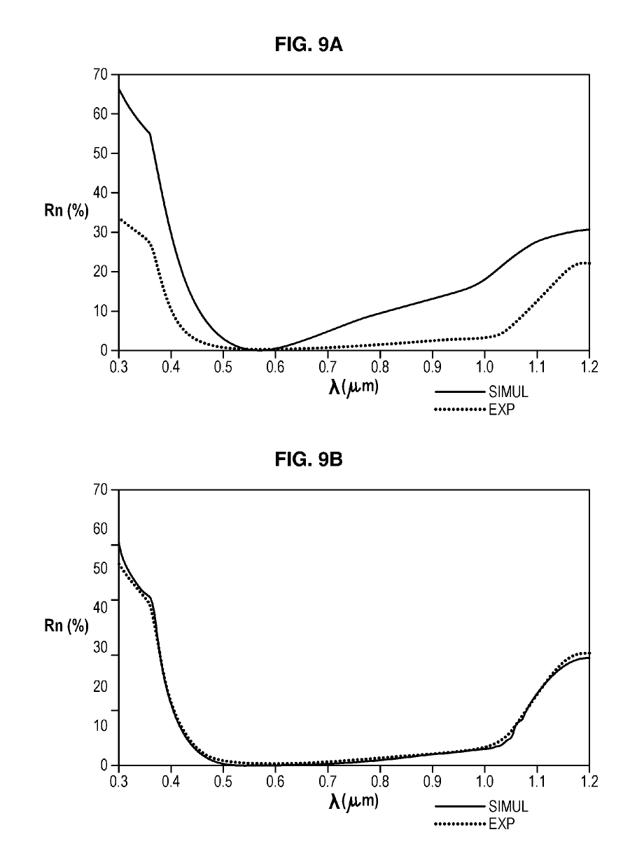

FIGS. 9A and 9B thus have comparative results of reflectivity Rn versus the wavelength λ obtained by simulation (curve SIMUL) and experimentally (curve EXP), for a solar spectrum AM1.5G and an optoelectronic device consisting in a solar cell, the surface of which is textured.

In this case, said textured surface consists of regular pyramids with a square base and for which the angle of the flanks relatively to the base is 54.74°; the average width of one side of the base being 5 μm.

In FIG. 9A, the optical simulation was carried out according to a method of the prior art, by modeling the cell as a structure having a planar surface and with illumination normal to the surface.

There exists a significant shift between the experimental curve and the simulated curve, expressing poor representativity of the simulation.

In FIG. 9B, the optical simulation was carried out according to the invention, by modeling the cell as a structure having a planar surface and with the illumination conditions I1*, I2* as defined above.

Excellent correlation is observed between the experimental curve and the simulated curve, which allows validation of the relevance of the simulation according to the invention.

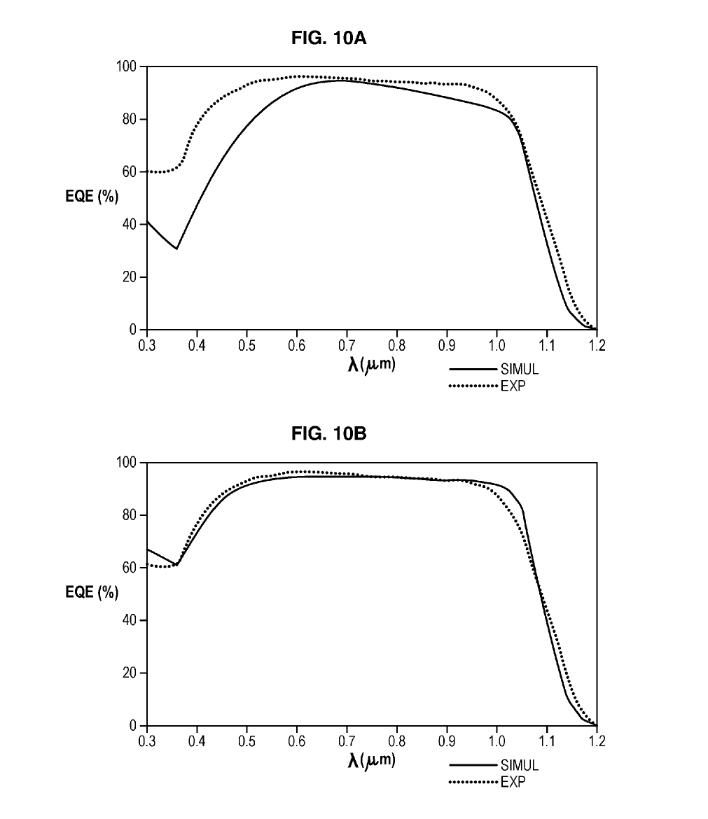

FIGS. 10A and 10B as for them show the comparative results of the quantum efficiency EQE versus the wavelength λ obtained by simulation (curve SIMUL) and experimentally (curve EXP), for a solar spectrum AM1.5G and an optoelectronic device identical with the one subject of FIGS. 9A and 9B.

In FIG. 10A, the electric simulation was carried out according to a method of the prior art, by modeling the cell as a structure having a planar surface and with illumination normal to the surface.

There exists a significant shift between the experimental curve and the simulated curve, expressing poor representativity of the simulation.

In FIG. 10B, the electric simulation was carried out according to the invention, by modeling the cell as a structure having a planar surface and with the illumination conditions I1*, I2* as defined above.

Excellent correlation is observed between the experimental curve and the simulated curve, which allows validation of the relevance of the simulation according to the invention.

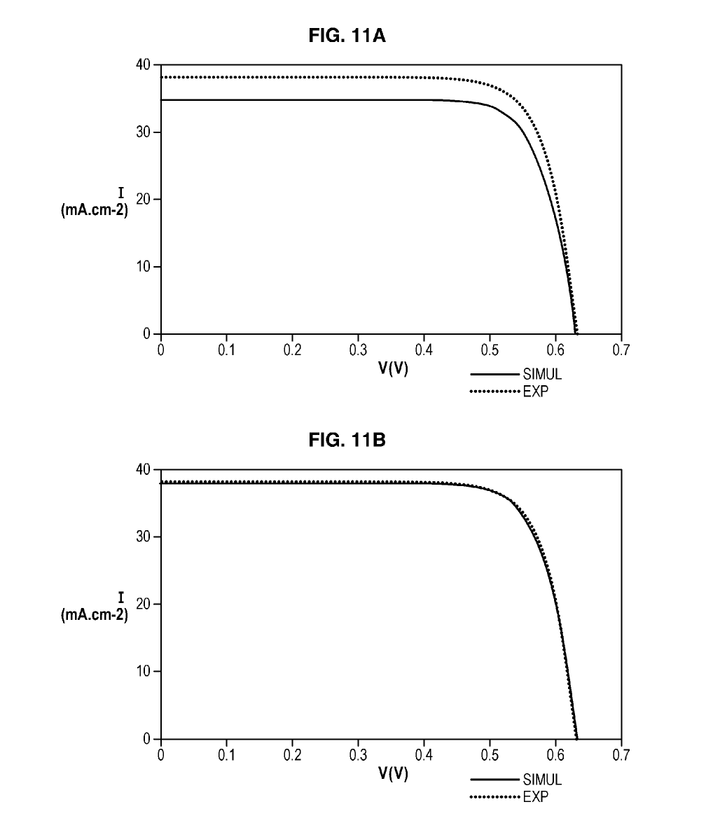

Finally, FIGS. 11A and 11B show comparative results of the current density I versus the voltage V obtained by simulation (curve SIMUL) and experimentally (curve EXP), for a solar spectrum AM1.5G and an optoelectronic device identical to the one subject of FIGS. 9A, 9B, 10A and 10B.

In FIG. 11A, the electric simulation was carried out according to a method of the prior art, by modeling the cell as a structure having a planar surface and with illumination normal to the surface.

There exists a significant shift between the experimental curve and the simulated curve, expressing poor representativity of the simulation.

In FIG. 11B, the electric simulation was carried out according to the invention, by modeling the cell as a structure having a planar surface and with the illumination conditions I1*, I2* as defined above.

Excellent correlation is observed between the experimental curve and the simulated curve, which allows validation of the relevance of the simulation according to the invention.

The optical and electric simulation method which has just been described may be used for different purposes.

For example, it may give the possibility of optimizing the anti-reflective layers of a solar cell by taking the surface texturation into account.

For example, this optimization may comprise the optimization of the thicknesses of the anti-reflective layers for a given material, or further the selection of a material intended to form one of these layers according to its optical properties.

It also gives the possibility of evaluating the effect of this optimization on the electric behavior of the cell.

This method may also allow evaluation of the effect of a surface texturation on the optical and electric behavior of an optoelectronic device which is non-textured, or conversely the evaluation of the performance of a textured device if its texturation is suppressed.

### Alternative Embodiments

As mentioned above, there may exist particular cases for which the assumption according to which two reflections on facets are representative of the path covered by all the rays is not verified.

Particular embodiments of the invention give the possibility of taking this into account and to nevertheless provide accurate results.

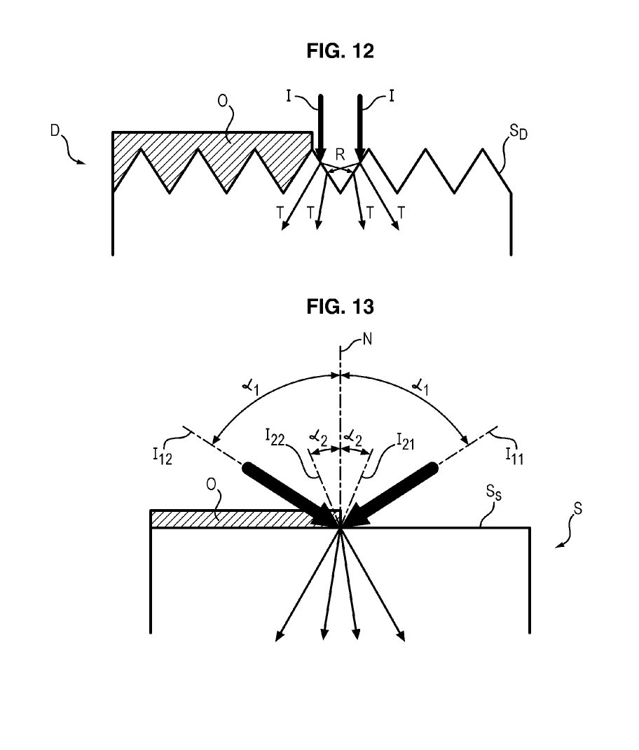

Thus, according to a first alternative of the invention, schematized in FIG. 12, the optoelectronic device D has, on its illuminated textured surface S_{D}, an opaque area O partly covering said surface.

Said opaque area may for example be an electric contact deposited at the surface of the device.

In this case, about half of the incident rays are deviated in order to penetrate under the opaque area, while the other half does not penetrate therein.

Therefore, according to the orientation of the beams I₁ and I₂ defined above, the incident light is either totally directed towards this opaque area—leading to over estimation of the effect of the light in this region), or totally directed out of this area—leading to under estimation of the effect of the light in the region located under the opaque area.

In order to avoid this error in the final reflectivity, an alternative of the method described above comprises the modeling of the first beam I₁ as a first half-beam I₁₁ directed towards the opaque area and a second half-beam I₁₂ symmetrical relatively to the normal N to the surface S_{S} (cf. FIG. 13).

Each half-beam I₁₁, I₁₂ is tilted relatively to said normal N with an angle α₁ defined above and has an intensity equal to half of that of the first beam I₁.

Similarly, the second beam I₂ is modeled as a first half-beam I₂₁ directed towards the opaque area and of a second half-beam I₂₂ symmetrical relatively to the normal N, each half-beam I₂₁, I₂₂ being tilted relatively to said normal N with the angle α₂ defined above and having an intensity equal to half of that of the second beam I₂.

Another particular case occurs when the angle of the facets relatively to a horizontal plane is greater than or equal to π/3 radians.

Indeed, in this configuration, the rays reflected twice on adjacent facets will systematically be incident to a third facet.

An alternative of the simulation method gives the possibility of taking into account this third reflection for improving the accuracy of the results.

After the simulation of the first and second beams I₁ and I₂ described above, a third simulation is applied with a third beam, for which the angle of incidence and the intensity are computed from those of the second beam I₂, in a similar way to how the properties of the second beam are computed from those of the first.

Another particular case occurs when the angle of the facets relatively to a horizontal plane is greater than or equal to 3π/10 radians but strictly less than π/3 radians.

Indeed, in this configuration, the rays reflected twice on adjacent facets have Non-zero probability but not equal to 1, which depends on the angle of the facets, of being incident on a first facet.

An alternative of the simulation method gives the possibility of taking into account this possible third reflection, with the corresponding probability, in order to improve the accuracy of the results.

After the simulation of the first and second beams I₁ and I₂ described above, a third simulation is applied with a third beam, for which the angle of incidence and the intensity are computed from those of the second beam I₂, in a similar way to how the properties of the second beam are computed from those of the first, but by weighting the intensity of the second beam with the probability that this third reflection occurs.

Finally, it is also possible to correct the possible errors of the optical path of the rays penetrating into the device, which may induce an error on the penetration of the photons in the device and therefore on their absorption probability.

For this purpose, according to an embodiment of the invention, the rays are artificially diverted after their transmission into the device, in order to give them the real angle relatively to the geometry of the device.

This real angle is computed depending on the angle of the facets of the cones relatively to the average surface Sₘ of the device.

This deviation may be applied by various numerical methods within the reach of the person skilled in the art, and may be programmed at any distance from the surface.

1. A method for optical and electrical simulation of an optoelectronic device, the surface of which intended to be illuminated has a texture formed with regular cones, under the effect of the illumination of said surface by an incident light beam having a determined intensity spectrum versus wavelength, said method being applied by a computer and comprising:
modeling the device as a structure for which the illuminated surface is modeled by a planar surface,
modeling the incident light beam by:
a first light beam tilted relatively to the normal to said surface with a first non-zero angle, simulating an angle of incidence of the incident beam on the texture of the surface of the device, and for which the intensity is equal to that of the incident beam, and
a second light beam tilted relatively to the normal to said surface with a second angle, simulating an angle of incidence of the reflected portion of the incident beam on the texture of the surface of the device,
simulating the illumination of the planar surface by said first and second light beams.

2. The method of claim 1, wherein each of said regular cones comprises a plurality of facets tilted by an identical angle relatively to an average planar surface of the surface of the device and said first angle is equal to the angle between a facet and said average planar surface.

3. The method of claim 2, wherein said regular cones are regular pyramids.

4. The method of claim 1, wherein the second angle is defined as being the angle of incidence of the reflected portion of the first beam on a facet adjacent to the facet to which is incident said first beam.

5. The method of claim 1, wherein the reflectivity of the first beam is computed from the simulation of the illumination of the planar surface by said first light beam.

6. The method of claim 1, wherein the reflectivity of the second beam is computed from the simulation of the illumination of the planar surface by the second light beam.

7. The method of claim 1, wherein the illumination of the planar surface is simulated by a third light beam tilted relatively to the normal to said surface with a third angle, said third angle being defined as being the angle of incidence of the reflected portion of the second beam on a facet adjacent to the facet to which is incident said second beam.

8. The method of claim 1, wherein the illuminated surface comprises an opaque area and wherein for the simulation
the first beam is modeled as a first half-beam directed towards the opaque area and as a second half-beam symmetrical relatively to the normal to the planar surface, each half-beam being tilted relatively to said normal with the first non-zero angle and having an intensity equal to half of that of the first beam and
the second beam is modeled as a first half-beam directed towards the opaque area and as a second half-beam symmetrical relatively to the normal to the planar surface, each half-beam being tilted relatively to said normal with the second angle and having an intensity equal to half of that of the second beam.

9. The method of claim 6, wherein the reflectivity of an incident beam on the textured surface is computed by performing the product of the reflectivities of the beams with which the illumination of the planar surface has been simulated.

10. The method of claim 6, wherein the intensity of the second beam is computed by multiplying the intensity of the first beam by the reflectivity of said first beam.

11. The method of claim 7, wherein the intensity of the third beam is computed by multiplying the intensity of the second beam by the reflectivity of said second beam.

12. The method of claim 11, wherein the intensity of the third beam is weighted with a probability coefficient depending on the angle of the facet.

13. The method of claim 6, wherein the incident beam is non-monochromatic and the reflectivity of the first, of the second and if necessary of the third beam is computed for each of a plurality of wavelengths sampled from the spectrum of said incident beam, and the reflectivity of said incident beam is computed by performing the product of the reflectivities of said beams for each of said wavelengths.

14. The method of claim 13, wherein an intensity spectrum of the second beam is computed by multiplying the intensity of the first beam by the reflectivity of said first beam for each of said wavelengths.

15. The method of claim 6, wherein the illumination of the planar surface is simultaneously simulated by the first and the second beam and the intensity absorbed by the structure is computed.

16. The method of claim 15, wherein the concentration of excess carriers in the structure under the effect of said illumination is inferred from said absorbed intensity.

17. The method of claim 16, wherein the external quantum efficiency and/or the characteristic of the current versus the voltage of the optoelectronic device are computed from said concentration of excess carriers.

18. The method of claim 1, wherein during the simulation, the portion of the first and/or of the second beam transmitted into the structure is computed and the tilt of said transmitted portion is corrected by diverting it.

19. A computer program product including a set of instructions which once they are loaded into a computer, allow the application of the method of claim 1.
